(19) United States
(12) Patent Application Publication
(10) Pub. No.: US 2020/0158541 A1
(43) Pub. Date: May 21, 2020

(54) POSITION DETECTING DEVICE FOR ROTARY SHAFT

(71) Applicant: Hiwin Mikrosystem Corp., Taichung City (TW)

(72) Inventors: Heng-Sheng HSIAO, Taichung City (TW); Zhi-Hao XU, Taichung City (TW)

(21) Appl. No.: 16/198,169

(22) Filed: Nov. 21, 2018

(51) Int. Cl. G01D 5/245

(52) U.S. Cl. CPC G01D 5/2455

(57) ABSTRACT

A position detecting device for a rotary shaft is provided. The position detecting device for a rotary shaft comprises a shaft, a coding element and a detecting element. The coding element comprises a body, a first coding unit and a second coding unit wherein the body is disposed on the shaft and coaxial to the shaft, and the first coding unit and the second coding unit are configured on the body. The first coding unit comprises a plurality of first tracks in an annular arrangement. The detecting element is disposed on an additional part and corresponding to the coding element for retrieving the signal of the first coding unit and the second coding unit.

### BACKGROUND OF THE INVENTION

### Field of the Invention

The invention relates to a position detecting device, and more particularly to a position detecting device for a rotary shaft.

### Description of the Related Art

For industrial automation and control, the conventional rotary encoder converts the angular position or motion into the movement information (rotation distance, velocity and angle) of a rotary shaft of a tool machine or a spindle motor.

In addition to the movement information of the rotary shaft, the eccentric rotation of the shaft resulted from the variation of the rotational inertia should be considered to prevent from the defect loss. Therefore, detecting the rotational shift of the shaft to enhance the processing accuracy becomes the challenge on the industrial automation and control.

### SUMMARY OF THE INVENTION

In view of the disadvantages of prior art, the object of the present invention is to provide a position detecting device for a rotary shaft to detect the rotational or axial shift of the shaft.

To achieve the above object, the position detecting device for a rotary shaft comprises a shaft, a coding element and a detecting element. The coding element comprises a body, a first coding unit and a second coding unit wherein the body is disposed on the shaft and coaxial to the shaft, and the first coding unit and the second coding unit are configured on the body. The first coding unit comprises a plurality of first tracks in an annular arrangement. The detecting element is disposed on an additional part and corresponding to the coding element for retrieving the signal of the first coding unit and the second coding unit.

In one embodiment of the present invention, the second coding unit is an incremental coding unit or an absolute coding unit.

In one embodiment of the present invention, the first tracks of the first coding unit are arranged along a radial direction perpendicular to the shaft.

In one embodiment of the present invention, the first coding unit is adjacent to the second coding unit in the radial direction perpendicular to the shaft.

In one embodiment of the present invention, the body is a circle formation.

In one embodiment of the present invention, the first tracks of the first coding unit are arranged along an axis direction of the shaft.

In one embodiment of the present invention, the first coding unit is adjacent to the second coding unit in the axis direction of the shaft.

In one embodiment of the present invention, the body is an encircled plate.

In one embodiment of the present invention, the detecting element is a hall sensor or a magneto-resistive sensor.

In one embodiment of the present invention, the body is made of the magnetic material or the magnetic permeable material.

### BRIEF DESCRIPTION OF THE DRAWINGS

FIG. 1 is a schematic view of the coding element of the first embodiment of the present invention;

FIG. 2 is a schematic view of the position detecting device for a rotary shaft of the first embodiment of the present invention;

FIG. 3 is a chart illustrating the variation of the magnetic field magnitude and the gap distance between the detecting element and the coding element;

FIG. 4 is a schematic view of the coding element of the second embodiment of the present invention; and

FIG. 5 is a schematic view of the position detecting device for a rotary shaft of the second embodiment of the present invention.

### DETAILED DESCRIPTION OF THE PREFERRED EMBODIMENTS

There are two embodiments illustrating the position detecting device for a rotary shaft of the present invention.

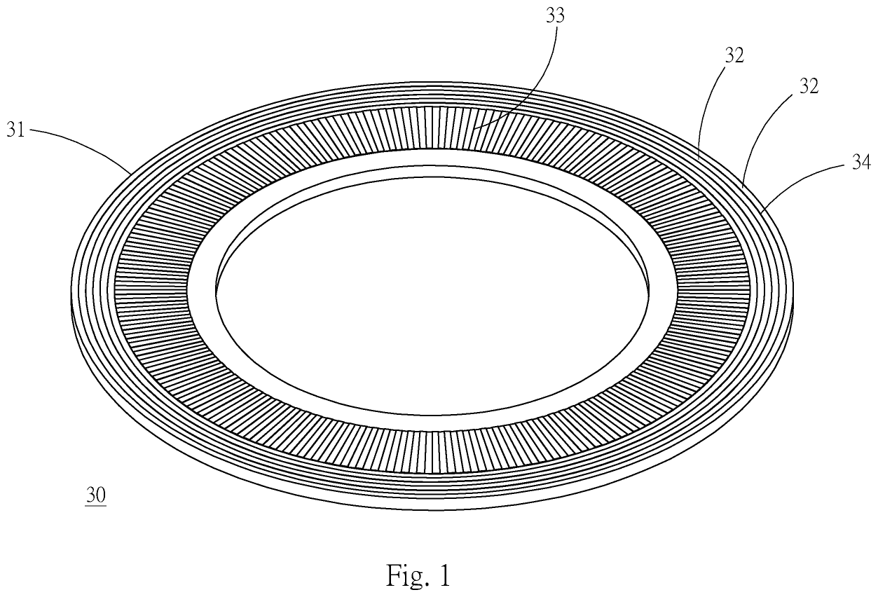

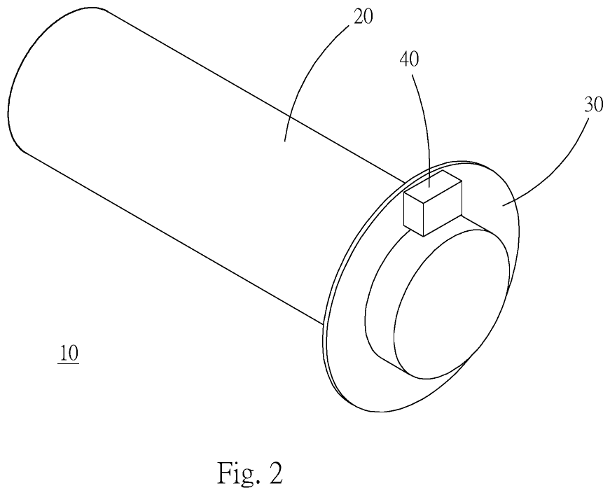

Refer to FIG. 1 and FIG. 2. The position detecting device for a rotary shaft 10 of the first embodiment of the present invention comprises a shaft 20, a coding element 30 and a detecting element 40.

The shaft 20 can be a rotary shaft of a tool machine or a spindle motor, and provided as a pillar or a tube formation.

The coding element 30 comprises a body 31 in a circle formation and made of the magnetic material or the magnetic permeable material, a first coding unit 32 and a second coding unit 33. The body 31 is rotatably disposed on and coaxial to the shaft 20. The first coding unit 32 and the second coding unit 33 are configured on the body 31 wherein the second coding unit 33 is configured adjacent to the shaft 20. The first coding unit 32 comprises a plurality of first tracks 34 in an annular arrangement. The second coding unit 33 is an incremental coding unit in this embodiment or an absolute coding unit in other embodiment.

The detecting element 40 is disposed on an additional part (not shown) and corresponds to the coding element 30 for retrieving the signal of the first coding unit 32 and the second coding unit 33. The detecting element 40 is a hall sensor in this embodiment or a magneto-resistive sensor in other embodiment. Besides, the abovementioned addition part is provided for fastening of the detecting element 40 to detect the rotary coding element 30, and the technology is well-known for the people skilled in the art so there is no more detailed description herein.

Specifically, the coding element 30 is rotated synchronously with the shaft 20 when the shaft 20 is driven for rotation such that the detecting element 40 retrieves the signal of the first coding unit 32 and the second coding unit 33 to provide the movement information. Compared with the conventional encoding technology, the position detecting device for a rotary shaft 10 of the present invention further detects the rotational shift of the shaft 20 to enhance the processing accuracy on the industrial automation and control.

With respect to the detecting mode, the detecting element 40 detects the annular first tracks 34 to provide the output A/B phase signals in the form of square waves wherein the amplitude of the square waves get higher as the increasing distance of the rotational shift. In other words, the amplitude of the square wave is kept in a steady situation when the shaft 20 rotates without the rotational shift and the amplitude of the square wave raises when the shaft 20 rotates with the rotational shift. Therefore, the distance of the rotational shift can be analyzed in accordance with the amplitude of the square wave. In addition, the rotational shift of the shaft 20 is detected through the variation of the magnetic field within the first coding unit 32, but the number of the first track 34 should not be limited herein.

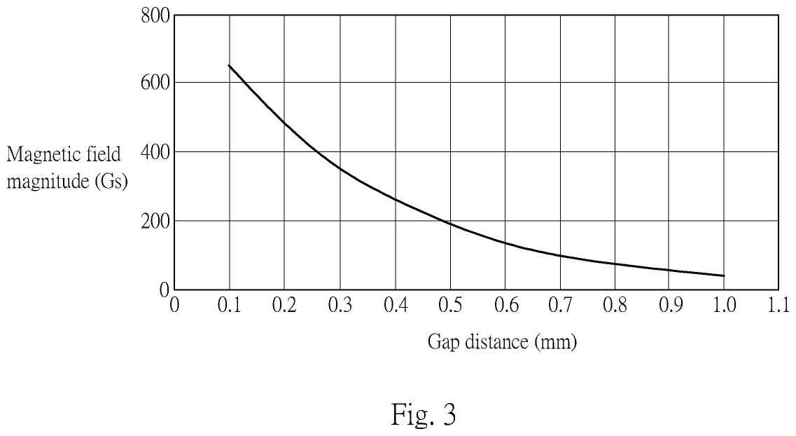

In addition to the detection of the shift along the radial direction, the analog sensor (not shown) is integrated with the detecting element 40 to sense the magnetic field of the coding element 30. Therefore, the shift distance along the axial direction of the shaft 20 can be analyzed in accordance with the chart of FIG. 3 illustrating the variation of the magnetic field magnitude and the gap distance between the detecting element 40 and the coding element 30.

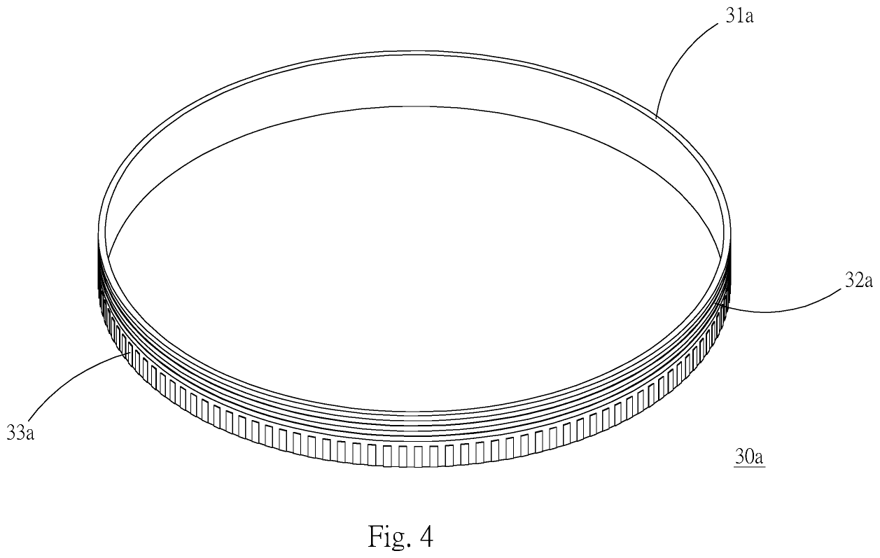

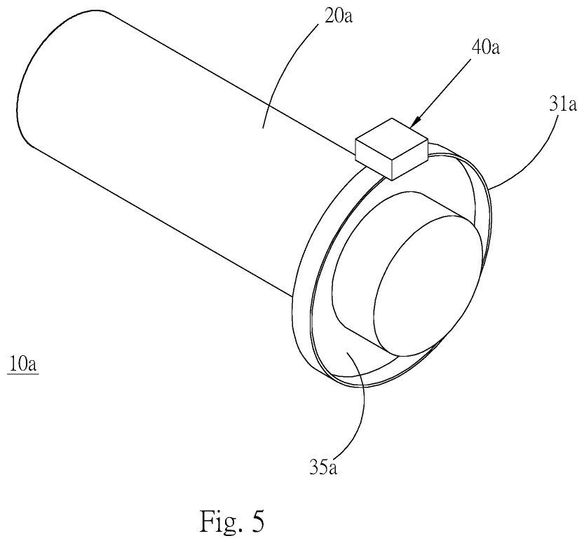

Refer to FIG. 4 and FIG. 5 which illustrates the position detecting device for a rotary shaft 10a of the second embodiment of the present invention. The detecting element 40 of the first embodiment senses the coding element 30 in the axial direction to analyze the shift along the radial direction, but the detecting element 40 of the second embodiment senses the coding element 30 in the radial direction to analyze the shift along the axial direction. In this embodiment, the second coding unit 33a is an incremental coding unit.

Specifically, the body 31a is an encircled plate disposed on the shaft 20a through a circular fixture 35a wherein the first coding unit 32a and the second coding unit 33a are configured on the periphery of the body 31a. Accordingly, the detecting element 40a disposed on an additional part and corresponding to the coding element 30a senses the magnetic field of the first coding unit 32a in the radial direction of the shaft 20a to analyze the shift along the axial direction.

It is to be understood that the above descriptions are merely the preferable embodiment of the present invention and are not intended to limit the scope of the present invention. Equivalent changes and modifications made in the spirit of the present invention are regarded as falling within the scope of the present invention.

What is claimed is:

1. A position detecting device for a rotary shaft, comprising:
a shaft;
a coding element, comprising a body rotatably disposed on the shaft and coaxial to the shaft, a first coding unit configured on the body, and a second coding unit configured on the body, wherein the first coding unit comprises a plurality of first tracks in an annular arrangement; and
a detecting element, disposed on an additional part and corresponding to the coding element for retrieving the signal of the first coding unit and the second coding unit.

2. The position detecting device for a rotary shaft as claimed in claim 1, wherein the second coding unit is an incremental coding unit or an absolute coding unit.

3. The position detecting device for a rotary shaft as claimed in claim 1, wherein the first tracks of the first coding unit are arranged along a radial direction perpendicular to the shaft.

4. The position detecting device for a rotary shaft as claimed in claim 3, wherein the first coding unit is adjacent to the second coding unit in the radial direction perpendicular to the shaft.

5. The position detecting device for a rotary shaft as claimed in claim 3, wherein the body is a circle formation.

6. The position detecting device for a rotary shaft as claimed in claim 1, wherein the first tracks of the first coding unit are arranged along an axis direction of the shaft.

7. The position detecting device for a rotary shaft as claimed in claim 6, wherein the first coding unit is adjacent to the second coding unit in the axis direction of the shaft.

8. The position detecting device for a rotary shaft as claimed in claim 6, wherein the body is an encircled plate.

9. The position detecting device for a rotary shaft as claimed in claim 1, wherein the detecting element is a hall sensor or a magneto-resistive sensor.

10. The position detecting device for a rotary shaft as claimed in claim 1, wherein the body is made of the magnetic material or the magnetic permeable material.
